(19) United States
(12) Patent Application Publication
(10) Pub. No.: US 2007/0043610 A1
(43) Pub. Date: Feb. 22, 2007

(54) Method for analysis of opinion polls in a national electoral system

(76) Inventor: Samuel Sheng-Hung Wang, Princeton, NJ (US)

Correspondence Address: Samuel S.-H. Wang;Princeton University, Department of Molecular Biology, LTL Bldg., Washington Road, Princeton, NJ, 08544, US

(21) Appl. No.: 11/489,104

(22) Filed: Jul. 19, 2006

Related U.S. Application Data
(60) Provisional application No. 60/595,611, filed on Jul. 19, 2005.

(51) Int. Cl. G07C 13/00

(52) U.S. Cl. 705/12

(57) ABSTRACT

An algorithm for analyzing presidential preference opinion polls to arrive at a statistical snapshot of a multistate electoral-vote-allocation political race such as the US presidential race. Multiple opinion polls are used to estimate the outcome probability in individual state races. Polls are used to calculate a probability distribution of all possible electoral vote outcomes. The algorithm includes a method for calculating a median electoral vote estimator at any moment during a campaign. The electoral vote estimator can be tracked over time. The estimation of single-state probability is done using a Bayesian method to correct for sampling biases and systematic errors in polls, thereby allowing correction of the overall estimate. The algorithm calculates the relative value of an individual vote, the jerseyvote, in different states. The jerseyvote valuation aids resource allocation by a political campaign or party, an advocacy organization, or an individual activist.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

This invention relates to the use of probabilistic estimation algorithms, specifically to such algorithms that are used to analyze public opinion polls.

2. Prior Art

In the United States, the electoral system for selecting a president is well-known for its complexity. In this system, known as the Electoral college (3 U.S.C. section 4), election for President of the United States and Vice President of the United States takes place every four years, and is indirect. Voters within the 50 states and the District of Columbia vote for electors who represent their preferred candidates for President and Vice-President. The number of electors assigned to each state (U.S. Constitution, Section 1, Article II) is equal to the total number of Senators, always two, and Representatives that the state has in Congress. These electors in turn cast the official votes for those two offices. In most states and in D.C., the plurality winner of the popular vote for President within that state receives all of the state's electors, while all other candidates receive none. Currently, the only exceptions to this rule are Maine and Nebraska, in which the plurality winner of each Congressional district receives one district elector, while the two at-large electors are given to the plurality winner of the whole state.

Because of the structure of the U.S. presidential electoral system, the winner of the election is not necessarily the candidate who receives the largest number of votes, that is, the winner of the popular vote. Instead, the race is determined by the outcome of 51 individual races. This raises difficulties in estimating the likely winner of the election at any given moment. National popular vote is not an accurate estimator, as illustrated in the 2000 and 2004 elections. In 2000, Albert Gore received over half a million more votes than George W. Bush, but was defeated in the Electoral College after a protracted recount in one state, Florida. In 2004, President Bush won the popular vote over Senator John Kerry by nearly three percentage points., but barely won in the Electoral College, 286 to 252.

Such a complex system for electing a president raises a significant challenge that is currently not met by opinion survey companies. Opinion survey companies monitor state races and national popular sentiment by conducting surveys. These surveys, known as polls, typically draw their sample from all adults, all registered voters, or voters meeting criteria as being likely to vote. Some of these surveys are used by news organizations as a source of information on the state of the campaign, and are made publically available. Other surveys are used privately by political campaigns, political parties, and advocacy organizations. Over the course of the 2004 Presidential campaign, over two thousand national and state polls were conducted and disseminated freely over broadcast and print news media in the United States. However, state and national polls are usually not reported in a systematic fashion. Indeed, at any given moment, polls, for instance, all those for a given state, can contradict one another. Although this uncertainty is to some extent unavoidable because of statistical sampling error in individual polls, the piecemeal reporting of polls renders the data a disjointed and nearly overwhelming stream of information.

Given sampling limitations, categorical prediction of any given state election is usually impossible, except in cases where the expected margin is very large. Therefore, up-or-down statements about individual states or about the state of the national electoral race are intrinsically unreliable, national polls especially so because they only track popular opinion averaged over the entire US population. Yet at present, estimates of the likely outcome of the presidential election usually begin with a categorical assignment of each state as being assigned for one candidate or another.

Pooling of data can give greater statistical certainty in estimating win probabilities. However, competitive pressure among organizations has discouraged pooling of data. News organizations usually rely on their own data alone. Indeed, little incentive exists to improve accuracy, since low accuracy leads to more frequent news stories, and therefore more readers or viewers.

Statistically rigorous information about the state of the Presidential race would carry value in two ways. First, as news value, a probability-based model would give a simpler measure of a large body of polling information. Second, a probabilistic approach to the Presidential race would allow an estimate of the power of an individual vote or state to affect the overall probability of victory. This information would be of use to candidates, political parties, campaign strategists, advocacy organizations, and individual voters. These entities currently fashion strategies in large part by intuition. Quantitative probabilistic methods would help these entities allocate resources on a more rational basis. A concerete example would be a decision regarding to what state an organization should deploy campaign workers to get out the vote for maximum effect on the overall election outcome.

Alternate means of predicting election outcomes exist in the literature. Strategies for predicting overall election outcomes have been devised based on economic growth, unemployment, and other variables that are measures of national mood or sentiment. These strategies, pioneered by Ray Fair (1978, The effect of economic events on votes for president, Review of Economics and Statistics, vol. 60, pp. 159-1973) and others (reviewed recently by Hibbs, 2000, Bread and peace voting in U.S. presidential elections, Public Choice, vol. 104, pp. 149-180), do not take into account empirical state-level opinion data, nor do they provide information that would be useful for tracking sentiment over time. Furthermore, they provide no basis for deploying resources as dictated by the complexities of the US electoral system.

One recent strategy (Soumbatiants, Chappell, and Johnson, 2006, Using state polls to forecast U.S. presidential election outcomes, Public Choice, vol. 127, pp. 207-223) has used state poll information. However, that work focused on single-state probabilities, and did not make any calculation of any overall probability distribution. Instead, the estimated outcome was arrived at by Monte Carlo simulation in which a small number of possible outcomes was selected at random 10,000 times. Their method did not take into account the entire distribution of plausible outcomes, which can number in the millions or greater. Also, the method was only used to make a retrospective estimate of outcome, i.e. to make a binary prediction after the election had passed. No attempt was made to track a prediction over time, or to make recommendations for deployment of campaign resources.

### OBJECTS AND ADVANTAGES

The present invention provides a means of dynamically extracting a statistical snapshot of the US Presidential race, or another political race with similar electoral structure, using state polling margin data. Because statistical estimates made by aggregating measures are more accurate than the individual measures, a meta-analytical approach is more informative than the information available through individual polls to a citizen, a polling organization, a campaign, or an advocacy organization.

An object of the present invention is to provide an estimated electoral vote, or EV, total and win probability without the necessity of being certain about the expected outcome in any individual state. The algorithm's probabilistic approach allows a statistical confidence interval to be placed on the EV total. The use of state polls taken over an election season allows this EV estimate to be followed over time as a means of tracking the dynamics of the political race. The use of polling margins to calculate,a candidate's win probability also allows knowledge of biases in polling data to be used as an input to correct the algorithm.

Another object of the present invention is to provide a valuation of an individual citizen's vote, as measured by the relative likelihood of influencing the win probability depending on the voter's state of residency. This places a concrete value on individual votes and voter mobilization efforts on a per-vote basis. This calculation is an information source useful to individual activists, candidates, political campaigns and parties, advocacy organizations, and news organizations.

A working version of the invention was used during the 2004 U.S. Presidential campaign, and is still visible at the Web site http://election.princeton.edu, which was unveiled on Jul. 19, 2004 by a posting on the political Web site http://dailykos.com. The Electoral Meta-Analysis Web site attracted hundreds of thousands of visitors, inspiring several imitators along the way. A story appeared on the front page of The Wall Street Journal on Oct. 26, 2004, with a follow-up story on Nov. 4, 2004 in the same newspaper regarding the high accuracy of the analysis. The Electoral Meta-Analysis was featured as a story on the Fox News Channel on Oct. 30, 2004 and by several broadcast media organizations.

### SUMMARY

In accordance with the present invention an algorithm comprises the conversion of public opinion polls to a probability distribution of electoral vote outcomes, an effective margin in units of overall votes, and a valuation of individual votes in the various states from which the polls were taken.

### DRAWINGS—FIGURES

Other objects, features or advantages of the invention will be more fully understood and appreciated after consideration of the following description of the invention, which includes as a part thereof the accompanying illustrations of an implementation of the invention, wherein:

FIG. 1 illustrates a flowchart of an algorithm that carries out the invention.

FIG. 2 illustrates an implementation of an algorithm as source code in the language MATLAB to calculate the probability, distribution of possible electoral outcomes, the median number of expected electoral votes, and the popular meta-margin.

FIG. 3 illustrates an example of use of the algorithm of FIG. 2 to calculate the cumulative probability distribution of possible electoral outcomes.

FIG. 4 illustrates an example of use of the algorithm of FIG. 1 to track campaign standings over time.

FIG. 5 illustrates an implementation of an algorithm as source code in the language MATLAB to calculate the relative value of an individual citizen's vote depending on state of residence.

FIG. 6 illustrates output of an implementation of the algorithm of FIG. 5 to calculate the relative value of an individual citizen's vote depending on state of residence.

### DETAILED DESCRIPTION OF THE INVENTION-PREFERRED EMBODIMENT

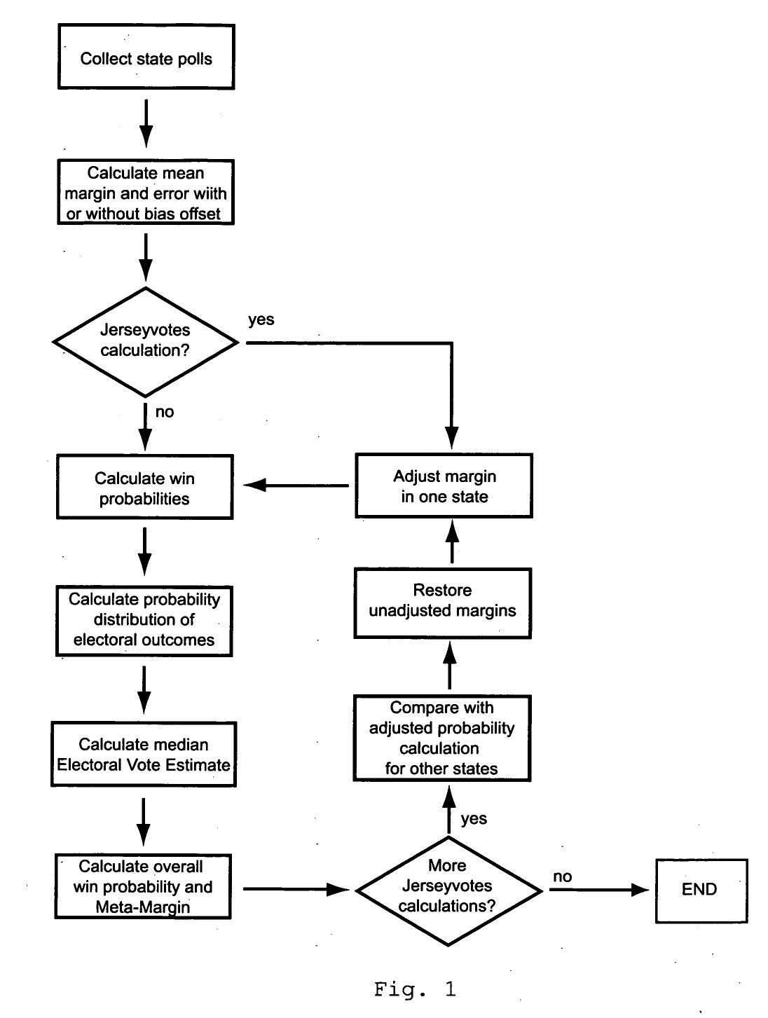

The core of the algorithm is an Electoral Meta-Analysis (FIG. 1) in the form of a calculation based on state polls from many polling organizations. The most typical data source is likely-voter opinion polling. Opinion polls take the form of individually released polls or rolling averages provided by organizations that release data to the public on a regular basis.

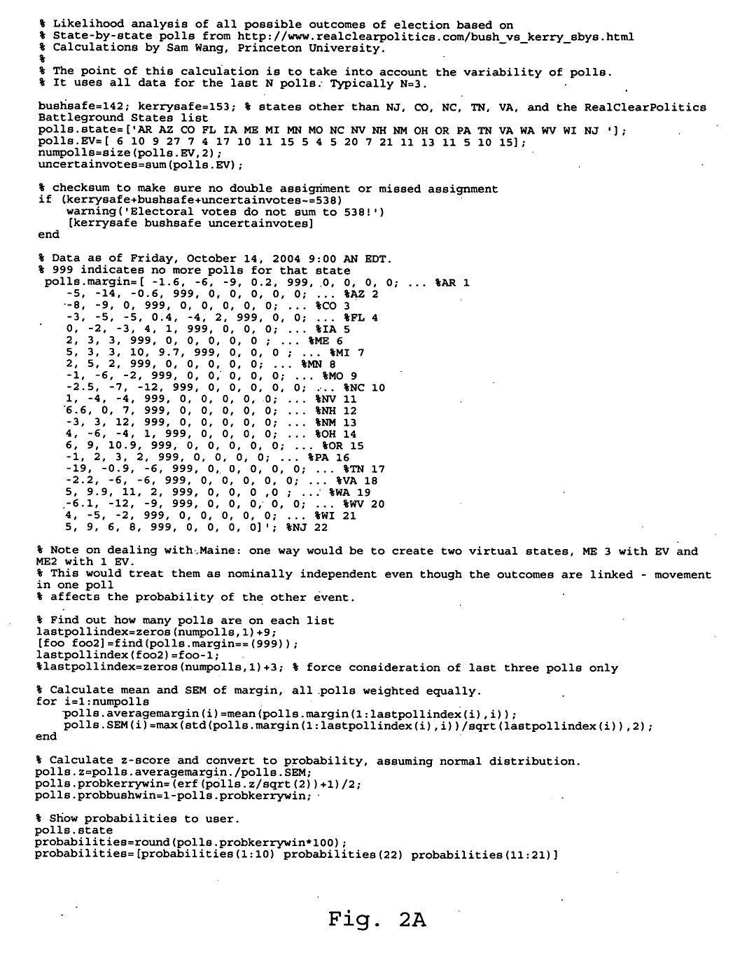

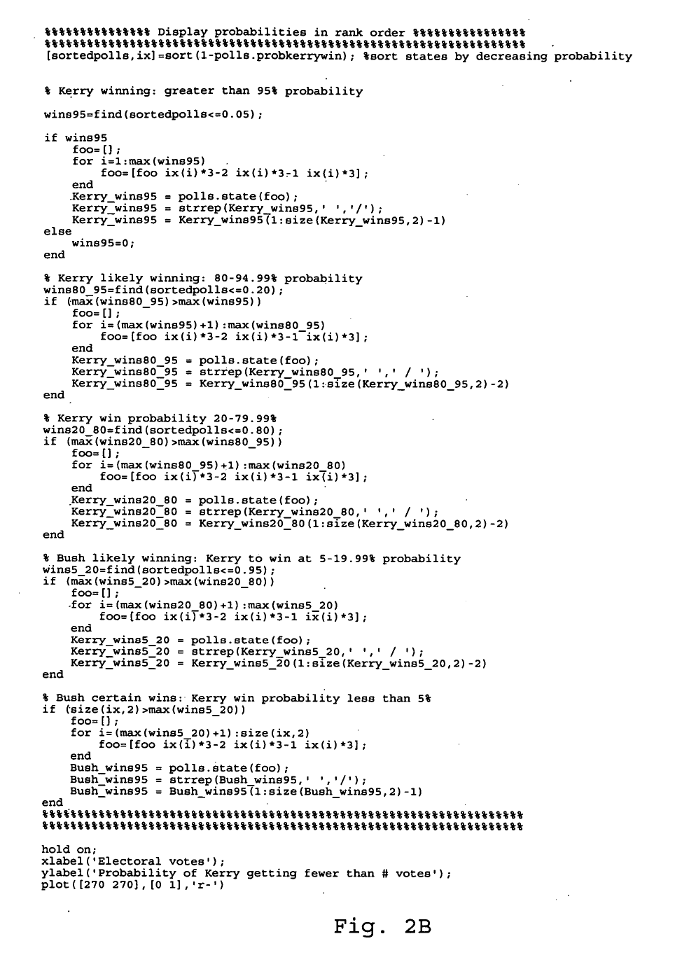

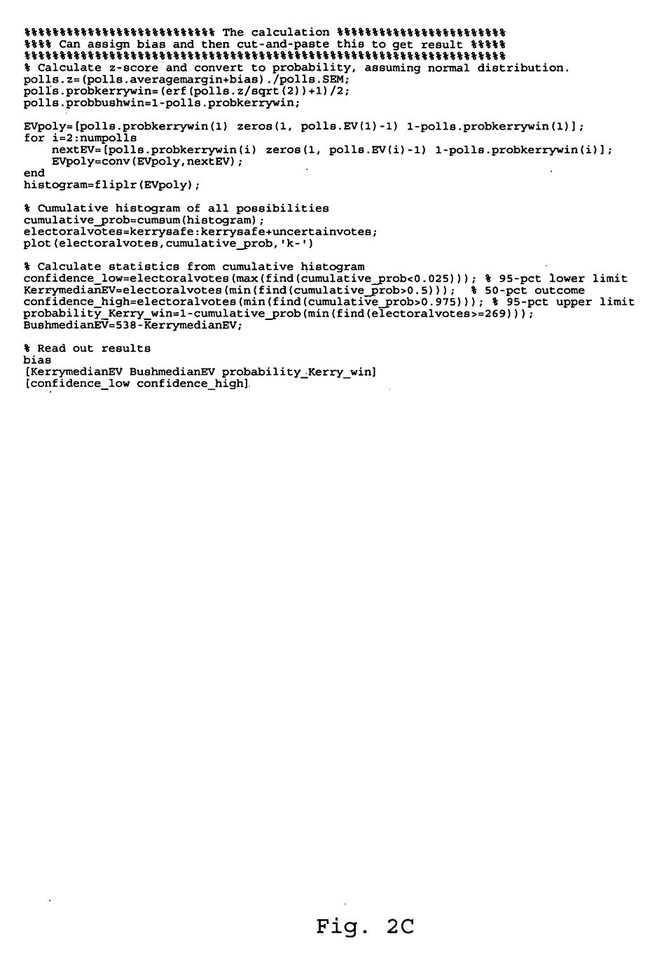

FIGS. 2-3—Calculating a Probability Distribution of Electoral Outcomes from Polls

Polling results are fed into an algorithm that mathematically computes the relative probability of all possible outcomes. The source code (FIG. 2) can be run on any computer running the mathematical analysis and modeling language MATLAB. The calculation, which is a meta-analysis, provides more objectivity and precision than looking at one or a few polls, and in the case of election prediction gives a more accurate current snapshot. Calculations are based on all available state polls, which are used to estimate the probability of a win, state by state. These are then used to calculate the probability distribution of all possible combinations of battleground state results.

The first step is to calculate the probability of winning each state, taking into account the variability of polls. Single-state probabilities are calculated by tabulating simple statistics on the polls: average and standard error of the mean, or SEM. Average and SEM are then converted to a probability of a win using the normal distribution, or bell-shaped curve. Many distributions other than a normal distribution can be chosen depending on details of statistical requirements imposed by input the data or the analysis. The probabilities are calculated in a number of ways: from the empirically calculated SEM, by assuming that the SEM cannot go below a minimum value such as 2 percent or a value determined from the sampling errors of the individual polls, or by calculating biases and errors of individual polling organizations. In the case of the normal distribution, for example, if a mean polling margin is 4 percent for candidate A with an SEM of 4 percent, the probability that A would win is approximately 84 percent because statistically, an approximately 16 percent chance exists that the outcome will be a negative margin, i.e. A loses.

The second step of the calculation (FIG. 3) is to calculate the probability of every possible outcome. In order to reduce computing time, individual-state probabilities less than a predetermined lower limit such as 0.1 percent or greater than a predetermined upper limit such as 99.9 percent are classified as certain outcomes. In the recent 2004 Presidential race, approximately 30 states were classifiable in this way. The remaining states require probabilistic consideration. For instance, for 17 states the total number of possibilities would be 2 to the 17th power, or 131,072, and for 21 states the total number of possibilities would be 2 to the 21st power, or 2,097,152.

The probability distribution can be calculated either by enumerating all possibilities or by using a binomial expansion in the form of a product of terms ((1−p_i)+p_i*xˆn_i), where candidate A wins state i, worth n_i electoral votes, with probability p_i, and x is a dummy variable. The product of all such terms takes the form of a polynomial a0+a1*x+a2*xˆ2+. . . . The probability of getting zero electoral votes is a0, the probability of getting one electoral vote is al, and so on. The overall probability distribution can be simply read off the polynomial coefficients. In this way it is possible to calculate a distribution for N contests in of order Nˆ2 computational steps rather than of order 2ˆN computational steps, leading to a considerable savings in computational time.

To illustrate the logic of the calculation, consider a presidential race in which, in order to win, candidate A must win either Ohio or Florida. His/her average poll standings in these states are exact ties, making his/her win probability 50 percent in each state. The four options, each with a probability of 25 percent, are: win both Ohio and Florida, win Ohio and lose Florida, lose Ohio and win Florida, lose both Ohio and Florida. Therefore his/her overall win probability for the national election is 75 percent. In the real calculation, a larger number of states would be used with individual probabilities anywhere between 0 and 100 percent.

In the third step, each possibility corresponding to a different number of EV is considered. All possibilities are tabulated in order of ascending number of EV to come up with a 50th-percentile, known as an Electoral Vote Estimator, as well as a 95-percent confidence interval, or other range of probabilities. The 95-percent confidence interval is particularly useful because, as a margin of error, it gives the range of outcomes that would occur 95 percent of the time based on the available information.

The calculation is typically done using recent polls for each state. In one implementation, it uses the most recent three polls at any given moment, typically spread over 1-4 weeks. Polls are unfiltered and equally weighted, in part because selecting data leads to unintended biases. In additional implementations, polls can be excluded from the calculation by outlier rejection methods that are common practice in statistics.

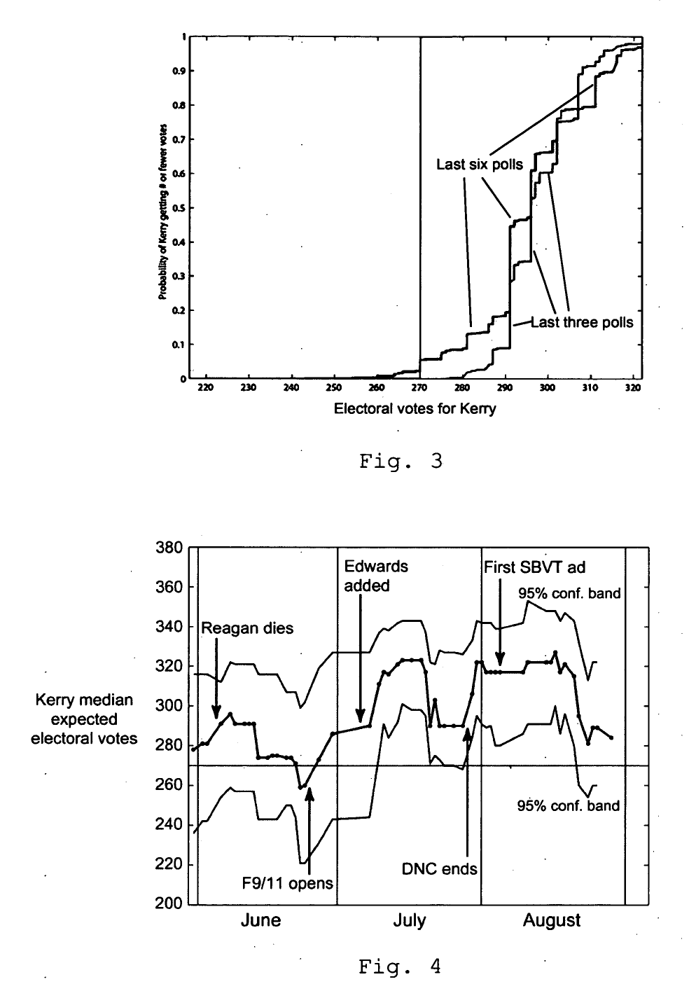

FIG. 4—Tracking Expected Electoral Outcome Over Time and a Correction for Polling Biases

The Electoral Vote Estimator can be used to track campaign history in units of hypothetical election outcomes on a day-by-day basis. The algorithm tracks campaign history by tracking electoral vote estimates over time (FIG. 3). For the history calculation each poll is assigned to a date associated with the polling period, such as the first, middle or last date on which polling was done. The effect of events is therefore precisely represented because of the use of polling margins and because of averaging over multiple polls.

The algorithm can be used to take into account polling biases. A difference between poll results and the actual outcome if an election were held would occur if, on average, poll respondents differed from actual voters in their sentiments. An overall poll bias, if strong enough, can have a large effect in a close race. Such a bias can occur if polling methods do not accurately sample actual voting patterns. Polling bias can happen if polling organizations do not identify likely voters accurately, if one side turns its voters out better or worse than predicted, or if new voter registrations are not accurately reflected in the survey population. Another factor of unknown size is the possibility that voters who do not express a preference will break unevenly when voting takes place.

Bias is accounted for in the analysis by calculating probabilities based on average poll margins with an offset added or subtracted. This allows a corrected margin to be obtained and therefore a revised estimate of a win probability. This can be propagated through the entire meta-analysis to arrive at a new electoral vote estimate.

Bias analysis can be used to estimate the value of boosting turnout for a candidate. For example, if turnout efforts are estimated to boost candidate A's margin by N points, this quantity would be added to that candidate's margin in all states, and single-state probabilities recalculated.

The bias calculation is also used to arrive at a key measure of the closeness of a race called the Swing Index, also known as the Popular Meta-Margin. The Swing Index/Popular Meta-Margin is defined as the across-the-board percentage shift in opinion, or poll bias, in all states at once, that would be needed to make the electoral college an exact toss-up. This is analogous to the popular margin in national polls, but unlike the popular margin is the actual shift that would be needed to nullify an estimated electoral advantage.

Since the median EV estimate is very sensitive to swings in reported opinion because of the winner-take-all mechanism of awarding EV, the Swing Index/Popular Meta-Margin gives a quantitative measure of the number of votes needed to alter an election outcome. Historically, the Electoral College margin has shown, on average, a 29 EV margin per 1% popular margin. For comparison, past EV outcomes were as follows, where a positive margin indicates that the winning candidate also won the popular vote.

| | | |
|---|---|---|
| 2000 | G. W. Bush | 271-266, popular margin −0.5 percent |
| 1996 | Bill Clinton | 379-159, popular margin +8.5 percent |
| 1992 | Bill Clinton | 370-168, popular margin +5.6 percent |
| 1988 | G. H. W. Bush | 426-111-1, popular margin +7.8 percent |
| 1984 | Ronald Reagan | 525-13, popular margin +18.3 percent |
| 1980 | Ronald Reagan | 489-49, popular margin +9.8 percent |
| 1976 | Jimmy Carter | 297-240-1, popular margin +2.1 percent. |

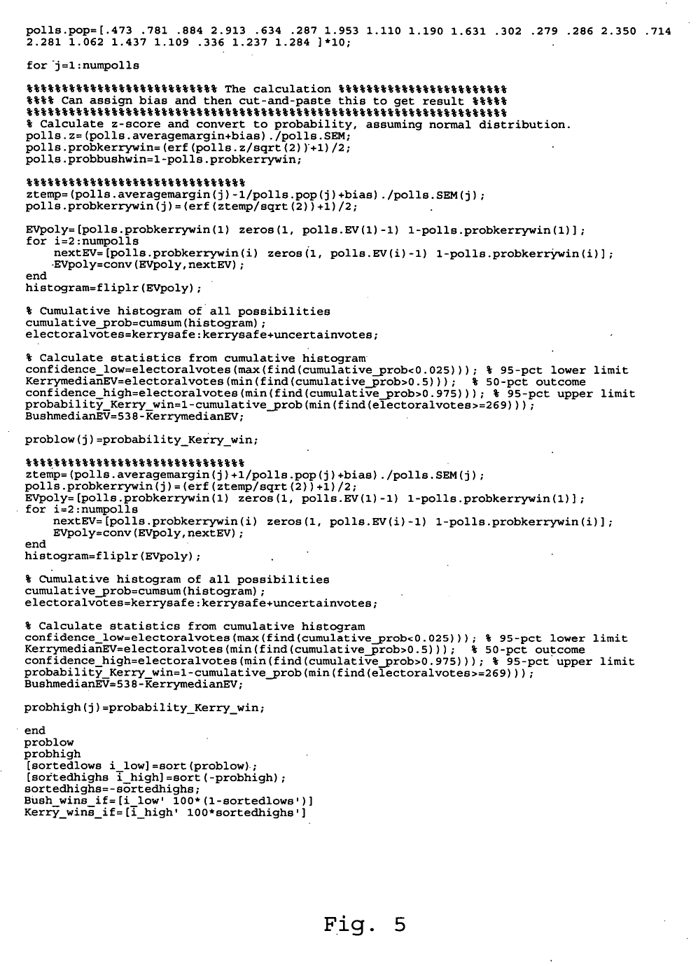

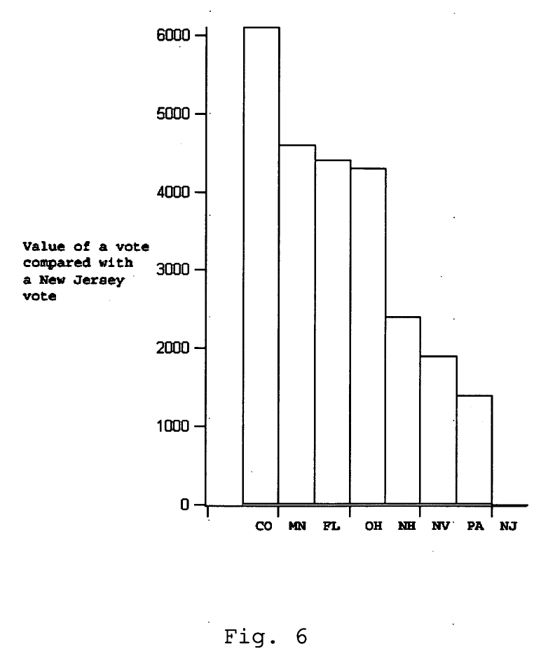

FIGS. 5-6—A Quantification of the Value of an Individual Vote

The value of an individual citizen's vote can be calculated (FIG. 5) using the algorithm by calculating the change in Electoral College win probability as a function of incrementing a state's margin by some fraction F, where F is inversely proportional to the state's voting population. This is calculated by moving the margin in an individual state by an infinitesimal amount and calculating the proportional change in the probability of the national race's outcome. An example source code listing in MATLAB (FIG. 5) shows an implementation of the value calculation.

For example, in the 2004 Presidential race, some states, for example, New Jersey, were overwhelmingly likely to vote Democratic; some states, for example, Texas, were overwhelmingly likely to vote Republican; and some states, for example, Ohio, were less certain. The power of individual voters was greatest in this last group, designated as Swing States. The algorithm quantifies the relative power of votes cast in these different states.

In one implementation of the algorithm (FIG. 6), the unit of comparison was the Jerseyvote, the power of a New Jersey voter to influence the national election. A vote in Ohio was typically worth over 500 Jerseyvotes. At one point in Fall 2004, the value of votes in key Swing States was as follows.
Iowa, 686 Jerseyvotes.
Ohio, 528 Jerseyvotes.
Nevada, 508 Jerseyvotes.
Florida, 372 Jerseyvotes.
New Mexico, 304 Jerseyvotes.
Wisconsin, 295 Jerseyvotes.
Pennsylvania, 295 Jerseyvotes.

### Other Embodiments

The present invention can be implemented as a computer program product that includes a computer program mechanism embedded in a computer-readable storage medium, and its outputs disseminated over the Internet or other information transmission medium. For instance, the computer program could contain (a) a module to parse poll data, (b) a software module for analysis of the algorithm's outputs, and (c) a server to provide the algorithm's outputs to a subscriber. These program modules may be stored on a CD-ROM, magnetic disk storage product, or any other computer-readable data or program storage product. The output of the computer program product may be distributed electronically, via the Internet or otherwise, by transmission of a computer data signal, in which either the software modules or their outputs are embedded, on a carrier wave.

Advantages

From the description above, a number of advantages of my Electoral Meta-Analysis become evident:

(a) The analysis reduces a large data set comprising numerous state polls into a single measure, the Electoral Vote Estimator, that can be tracked conveniently over time, as was done in 2004 on the Web site http://election.princeton.edu.

(b) The ability to re-calculate the Electoral Vote Estimator over time allows the evaluation within a few days of the political impacts of major news events, which in 2004 included release of the movie Fahrenheit 9/11, the addition of John Edwards to the Democratic ticket, the Democratic and Republication conventions, and the Presidential debates.

(c) The ability to account for polling biases allows a quantitative estimate of the possible impact of biases on the overall outcome, as well as shifts in sentiment, in terms of the Popular Meta-Margin.

(d) The ability to assign a quantitative value of an individual vote in units of Jerseyvotes allows activists to estimate the impact of increasing turnout in a given state by one vote, thereby allowing the calculation of the benefit per vote of get-out-the-vote efforts.

(e) The ability to assign a quantitative value of an individual vote in terms of Jerseyvotes facilitates the optimal deployment by an activist organization of resources such as advertising, candidate visits, and other campaign-related activities.

Conclusions, Ramifications, and Scope

Based on the description above, the reader will see that the Electoral Meta-Analysis can be used both as a tracking tool to provide an immediate evaluation of overall voter sentiment over time. Such a tracking tool is more accurate than any single poll, and generates news value. The application of Electoral Meta-Analysis to the calculation of Jerseyvotes is a means of mathematically calculating the value of individual votes, thereby allowing quantification of the possible benefits of camaigning, advertising, and get-out-the-vote activities.

It will be appreciated that, while reference was made to the US Presidential Electoral College, the present invention encompasses multi-state vote allocation systems of any kind. Thus, the estimates from the present invention include, but are not limited to, election systems of other nations and any entity in which votes from a part are assigned in blocks determined by votes taken within that part. Further, it will be appreciated that although reference is made to a system for generating the electoral and vote-value estimates having a client/server format, many embodiments of the present invention are practiced using a single computer that is not necessarily connected to the Internet. Further still, it will be appreciated that the concentration of software modules on one computing device is merely exemplary. For instance, embodiments in which the poll data parser, the analysis software module, and software to interpret outputs for a consumer reside independently on a client and/or a server fall within-the scope of the present invention.

The foregoing descriptions of specific embodiments of the present invention are presented for purposes of illustration and description. They are not intended to be exhaustive or to limit the invention to the precise forms disclosed; obviously, many modifications and variations are possible in view of the above teachings. The embodiments were chosen and described in an order to best explain the principles of the invention and its practical applications, to thereby enable others skilled in the art to best utilize the invention and various modifications as are suited to the particular use contemplated. Therefore, although the description above contains many specificities, these should not be construed as limiting the scope of the invention but as merely providing illustrations of some of the presently preferred embodiments of this invention. For instance, the calculation of state-by-state probabilities could take into account additional information such as knowledge of voter turnout patterns in one or more states; the polling bias could be estimated independently by using news information such as economic indicators or context-specific news stories such as the existence of a war; the timing window over which polls are averaged could be a fixed window, or a average weighted more heavily toward recent polls could be used in order to more accurately estimate voter sentiment at a given moment; and so on.

Thus the scope of the invention should be determined by the appended claims and their legal equivalents, rather than by the examples given.

I claim:

1. A method for evaluating opinion polls from a plurality of individual states as a means of arriving at a median electoral vote outcome, also known as an electoral vote estimator, comprising the steps of:
(a) calculating a plurality of mean margins of hypothetical state contest outcomes, and with each mean a corresponding error estimate,
(b) using said mean and error estimate to calculate a plurality of state level win probabilities,
(c) using said win probabilities to calculate a probability distribution spanning a range of possible electoral vote totals by a method selected from the group consisting of enumeration of possibilities and a binomial expansion, and
(d) using said probability distribution to calculate a median electoral vote estimate and a probable election outcome.

2. The electoral vote estimator of claim 1, further including recalculation of said estimator over time as a means of providing a tracking index.

3. The electoral vote estimator of claim 1, further including comparison of said estimator with previous values of said electoral vote estimate to evaluate the impact of newsworthy events on said probable election outcome.

4. The electoral vote estimator of claim 1, further including a calculation of an electoral meta-margin, also known as a polling bias or shift in public opinion in one or more states, that would be necessary to alter said electoral vote estimator by a predetermined number of electoral votes.

5. A method for calculating, from opinion polls conducted in a plurality of individual states, an estimated impact on an electoral win probability by a candidate of a small perturbation ranging from a single vote to a group of votes in at least one state, comprising the steps of:
(a) calculating an overall probability distribution of possible electoral vote outcomes from said opinion polls,
(b) adjusting data in at least one state by an amount corresponding to a change in voter turnout or a change in at least one individual vote, within at least one state,
(c) using said adjusted data to calculate changes in win probability in at least one state,
(d) using said change or changes in win probability in at least one state to calculate an effect on said overall win probability, and
(e) using said change in overall win probability to calculate a value of votes in one state relative to a value of votes in another state.

6. The vote values of claim 5, further including assignment of a value to monetary expenditures and human campaign effort in a particular state in terms of an effect on said electoral win probability.

7. A method for electoral meta-analysis of a multitude of publicly available estimates of state by state candidate margins to arrive at a single estimate of expected electoral vote outcome in a hypothetical election, whereby progress in a political campaign can be tracked and campaign resources can be allocated.

8. The method of electoral meta-analysis of claim 7, further including tracking of changes in said estimated electoral vote outcome over time.

9. The method of electoral meta-analysis of claim 7, further including an estimate of the effect of a newsworthy event on said estimated electoral vote outcome if said election were held after said newsworthy event.

10. The method of electoral meta-analysis of claim 7, further including corrections of state by state outcome probabilities using bayesian estimation, whereby systematic error in polling data values can be compensated.

11. The method of electoral meta-analysis of claim 7, further including estimation of an effect of changing an individual vote in a single state on said expected electoral vote outcome and an election outcome probability.

12. Quantifying said relative estimated effect of changing an individual vote of claim 11 in terms of a value of a change in said outcome probability caused by a change in votes in another state.

13. Using said value of individual votes as a means of allocating human or monetary resources to have a maximal effect on said election outcome probability.
